(19) United States
(12) Patent Application Publication
(10) Pub. No.: US 2025/0386088 A1
(43) Pub. Date: Dec. 18, 2025

(54) CAMERA MODULE

(71) Applicant: SAMSUNG ELECTRO-MECHANICS CO., LTD., Suwon-si (KR)

(72) Inventors: Wonjoon HWANG, Suwon-si (KR); Janghun KIM, Suwon-si (KR)

(73) Assignee: SAMSUNG ELECTRO-MECHANICS CO., LTD., Suwon-si (KR)

(21) Appl. No.: 18/933,183

(22) Filed: Oct. 31, 2024

(30) Foreign Application Priority Data
Jun. 13, 2024 (KR) 10-2024-0076883

(51) Int. Cl. H04N 23/54; G03B 17/12; G03B 30/00

(52) U.S. Cl. CPC H04N 23/54; G03B 17/12; G03B 30/00

(57) ABSTRACT

A camera module is provided. The camera module includes a lens module including at least one lens; an image sensor module including an image sensor disposed below the lens module, and a circuit board on which the image sensor is mounted; and an optical filter module including an optical filter, and a sub-housing configured to support the optical filter, and disposed between the lens module and the image sensor module, wherein a groove portion is disposed on an inner surface of the sub-housing, and the groove portion is spaced apart from a surface of the sub-housing that faces the circuit board.

### CROSS-REFERENCE TO RELATED APPLICATIONS

This application claims the benefit under 35 USC § 119 (a) of Korean Patent Application No. 10-2024-0076883, filed on Jun. 13, 2024, in the Korean Intellectual Property Office the entire disclosure of which is incorporated herein by reference for all purposes.

### BACKGROUND

### 1. Field

The following description relates to a camera module.

### 2. Description of the Background

With the development of information communication technology and semiconductor technology, the distribution and implementation of electronic devices has rapidly increased. Recently, cameras are implemented in portable electronic devices such as, but not limited to, smartphones, tablet personal computers (PCs), and laptop computers.

Recently, as the implementation of high-pixel sensors and the number of sensor pads in camera modules has increased, connection pad arrangement on the circuit board is increasingly implemented with a complex structure of three or more rows, and in line with a miniaturization trend of portable electronic devices equipped with camera modules, ultra-thin form factor of camera modules is also desired. As a result, the implementation space of a circuit board is limited, and a demand for a camera module that can reduce a height of a sensor package as much as possible while minimizing the expansion of left and right widths is increasing.

This camera module includes a circuit board on which an image sensor is mounted and an optical unit including at least one lens that transmits images to the image sensor. Additionally, it may further include an optical filter between the image sensor and the optical unit to block light of a specific frequency bandwidth from light passing through the lens from entering the image sensor.

The image sensor is connected to the circuit board by wire bonding, and the optical filter is disposed in a sub-housing with a hollow portion to be fixed to the circuit board by an adhesive. In this example, as the adhesive hardens, an overflow phenomenon occurs where the adhesive overflows into the inside of the sub-housing.

A height of the sub-housing is limited in accordance with ultra-thin camera module requirement, so the adhesive that overflows inside the sub-housing attaches to the bonding wire, and an upper surface of the bonding wire and the sub-housing may be bonded. As a result, connection performance between the image sensor and the circuit board may be deteriorated or the connection may become unstable. Particularly, if a fine impact is applied after the camera module is completed, a defect may occur in which the wire connection between the image sensor and the circuit board is broken.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a lens module comprising at least one lens; an image sensor module comprising an image sensor disposed below the lens module, and a circuit board on which the image sensor is mounted; and an optical filter module comprising an optical filter, and a sub-housing configured to support the optical filter, and disposed between the lens module and the image sensor module, wherein a groove portion is disposed on an inner surface of the sub-housing, and the groove portion is spaced apart from a surface of the sub-housing that faces the circuit board.

The image sensor may be connected to the circuit board by a bonding wire, and the groove portion may be disposed around at least a portion of a region where the bonding wire is disposed.

The camera module may further include a bonding layer disposed between the sub-housing and the circuit board, wherein a portion of an adhesive material constituting the bonding layer is accommodated in the groove portion.

The groove portion may include a first groove portion that is spaced apart by a first distance from the surface of the sub-housing that faces the circuit board, and a second groove portion that is spaced apart by a second distance from the surface of the sub-housing that faces the circuit board.

A protrusion may be further disposed on the inner surface of the sub-housing, and the protrusion may be spaced further apart from the surface of the sub-housing that faces the circuit board than the groove portion.

The sub-housing may include a hollow upper surface portion, and a base portion that extends downward from an edge of the upper surface portion and is coupled to the circuit board, and the groove portion may be disposed on an inner surface of the base portion.

In a general aspect, a camera module includes an image sensor; a circuit board on which the image sensor is mounted; an optical filter disposed on the image sensor; and a sub-housing configured to support the optical filter, wherein a protrusion is disposed on an inner surface of the sub-housing, and the protrusion is spaced apart from a surface of the sub-housing that faces the circuit board.

The image sensor may be connected to the circuit board by a bonding wire, and the protrusion may be disposed around at least a portion of a region where the bonding wire is disposed.

The camera module may further include a bonding layer disposed between the sub-housing and the circuit board, wherein a portion of an adhesive material constituting the bonding layer may be accommodated at a lower portion of the protrusion.

The protrusion may include a first protrusion that may be spaced apart by a first distance from the surface of the sub-housing that faces the circuit board, and a second protrusion that may be spaced apart by a second distance from the surface of the sub-housing that faces the circuit board.

A groove portion may be further disposed on the inner surface of the sub-housing, and the groove portion may be spaced further apart from the surface of the sub-housing that faces the circuit board than the protrusion.

The sub-housing may include a hollow upper surface portion, and a base portion that extends downward from an edge of the upper surface portion and is coupled to the circuit board, and the protrusion may be disposed on an inner surface of the base portion.

Other features and aspects will be apparent from the following detailed description, the drawings, and the claims.

### BRIEF DESCRIPTION OF DRAWINGS

FIG. 1 illustrates an exploded perspective view of an example camera module, in accordance with one or more embodiments.

FIG. 2 illustrates a perspective view of a portion of the example camera module shown in FIG. 1.

FIG. 3 illustrates a partial cross-sectional view taken along a line V-V′ of FIG. 2.

FIG. 4 illustrates a sub-housing of an example camera module, in accordance with one or more embodiments.

FIG. 5 illustrates a cross-sectional view of an adhesion state of the sub-housing shown in FIG. 3.

FIG. 6 illustrates a cross-sectional view of a portion of an example camera module, in accordance with one or more embodiments.

FIG. 7 illustrates a cross-sectional view of a portion of an example camera module, in accordance with one or more embodiments.

FIG. 8 illustrates a cross-sectional view of an adhesion state of the sub-housing shown in FIG. 7.

FIG. 9 illustrates a cross-sectional view of a portion of an example camera module, in accordance with one or more embodiments.

FIG. 10 illustrates a cross-sectional view of a portion of an example camera module, in accordance with one or more embodiments.

FIG. 11 illustrates a cross-sectional view of a portion of an example camera module, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may provide a camera module that prevents adhesive overflow at a junction between a sub-housing where an optical filter is disposed and a circuit board.

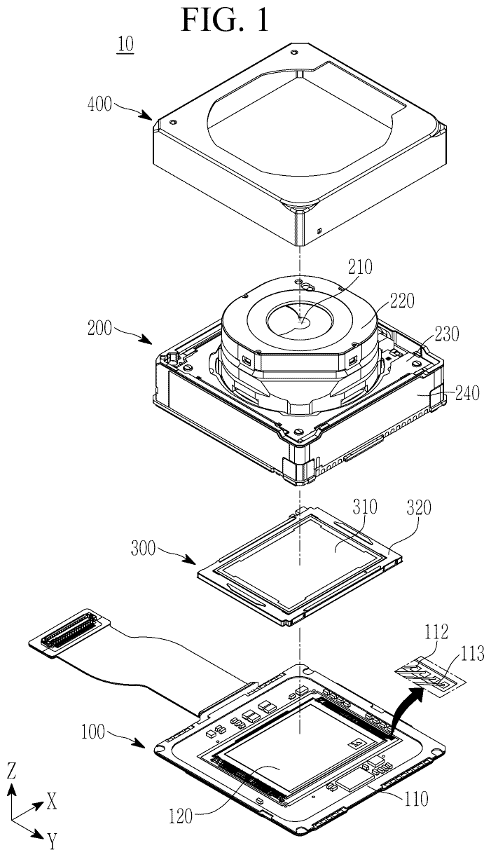

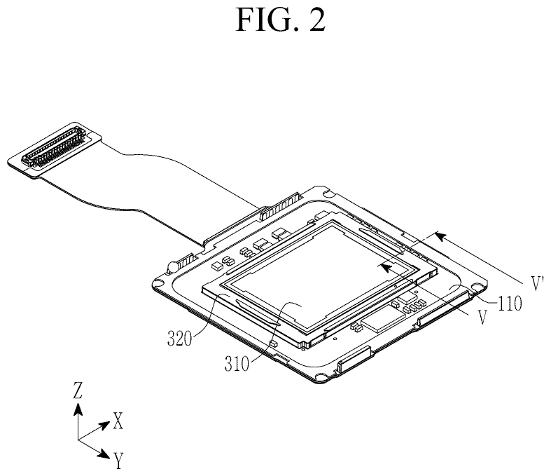

FIG. 1 illustrates an exploded perspective view of an example camera module, in accordance with one or more embodiments, and FIG. 2 illustrates a perspective view of a portion of the example camera module illustrated in FIG. 1.

Referring to FIGS. 1 and 2, the camera module 10, in accordance with one or more embodiments, includes an image sensor module 100, a lens module 200, an optical filter module 300, and a cover 400.

The image sensor module 100 includes a circuit board 110 and an image sensor 120. The circuit board 110 may include a circuit board that is electrically connected to a main board (not shown) and may have a wiring pattern that can be electrically connected, such as a rigid circuit board, a flexible circuit board, or a rigid flexible circuit board, as examples. The circuit board 110 may have one surface on which an image sensor 120 is mounted, and may include a connection pad 112 to enable a connection of the image sensor 120.

The image sensor 120, which is a device that converts light incident through the lens of the lens module 200 into an electrical signal, may be either a charge coupled device (CCD) or a complementary metal oxide semiconductor (CMOS). However, the one or more examples are not limited thereto.

The image sensor 120 may be disposed below the lens module 200 along an optical axis direction of the lens, and may be connected to the connection pad 112 of the circuit board 110 through a bonding wire 113. The connection between the image sensor 120 and the circuit board 110 is not limited thereto, and it is obvious that various modifications are possible for connection of electronic components mounted on the circuit board 110. The electrical signal converted by the image sensor 112 is outputted as an image through a display device of an electronic device.

The lens module 200 includes a lens 210, a lens barrel 220 that accommodates the lens 210, a lens driving device 230 that moves the lens barrel 220, and a housing 240 that accommodates the lens barrel 220. The lens 210 may include one or more lenses having the same or different optical characteristics such as a refractive index, and is mounted on the lens barrel 220 along an optical axis. In an example, the optical axis may be set to a central axis of the lens accommodated in the lens barrel 220, and the optical axis direction refers to a direction parallel to this central axis. The lens 210 may be disposed as desired depending on an implementation of the lens barrel 220.

The lens barrel 220 may have a hollow cylindrical shape such that one or more lenses 210 to image a subject can be accommodated therein, an image sensor 120 may be disposed below the lens barrel 220 along the optical axis to convert light incident through the lens barrel 220 into an electrical signal, and the converted electrical signal may be transmitted to the circuit board 110 and transmitted to an electronic device such as a mobile phone, as an example. The lens barrel 220 may move in a direction of the optical axis or in a direction perpendicular to the optical axis while accommodated in the housing 240 based on a driving force of the lens driving device 230.

The lens driving device 230 is a device that moves the lens barrel 220, and includes an auto focus (AF) driver (not shown) and an optical image stabilization (OIS) driver (not shown). In an example, the AF driver may include an AF driving magnet and an AF driving coil, and electromagnetic influence therebetween moves the lens barrel 220 along the optical axis to implement a focus adjustment operation or a zoom operation. Additionally, the OIS driver may include an OIS driving magnet and an OIS driving coil, and may implement an operation of correcting hand shake or shaking by moving the lens barrel 220 in a direction perpendicular to the optical axis based on the electromagnetic influence therebetween.

The housing 240 may accommodate the lens barrel 220 and the lens driving device 230 in an internal space, and in an example, the housing 230 may have a box shape with upper and lower portions which are open. The circuit board 110 may be disposed underneath the housing 230.

The optical filter module 300 may be disposed between the image sensor module 100 and the lens module 200, and may include an optical filter 310 and a sub-housing 320 that supports the optical filter 310. The optical filter 310 may be disposed on the image sensor 120, aligned with the lens 210 and the image sensor 120 along the optical axis direction, and may be arranged parallel to a direction perpendicular to the optical axis. The optical filter 310 may block light of a specific frequency bandwidth from light passing through the lens 210 from entering the image sensor 120. In an example, the optical filter 310 may include an infrared (IR) cut off filter.

The optical filter 310 may be disposed inside the sub-housing 320. The optical filter 310 may be fixed to the sub-housing 320 in various ways. In an example, the optical filter 310 may be adhesively fixed to the sub-housing 320 with an ultraviolet curing adhesive material or a heat curing adhesive material, where the adhesive material can be formed of an epoxy material. Additionally, it is also possible to use any possible adhesive such as adhesive tape, as an example.

The cover 400 may be coupled to the housing 240 to cover the housing 240. The cover 400 may have a frame shape with an open lower portion and four corners. The cover 400 protects internal components of the camera module 10. The cover 400 may be made of a metal plate or a material with a low corrosion rate, such as stainless steel, as an example. Additionally, the cover 400 may operate to block an electromagnetic wave. For example, the cover 400 may shield electromagnetic waves to prevent electromagnetic waves generated inside the camera module 10 from affecting other electronic components within the electronic device or noise currents flowing from outside the camera module 10 from affecting the inside of the camera module 10. The cover 400 may be grounded to the circuit board 110 to shield electromagnetic waves inside and outside the camera module 10.

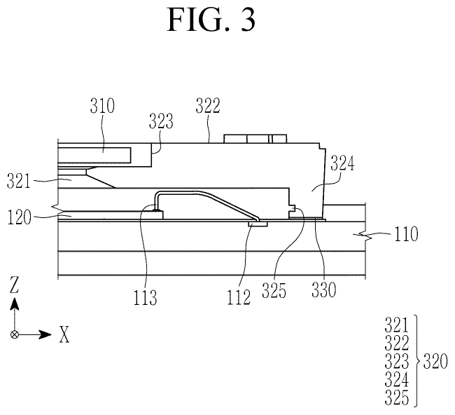

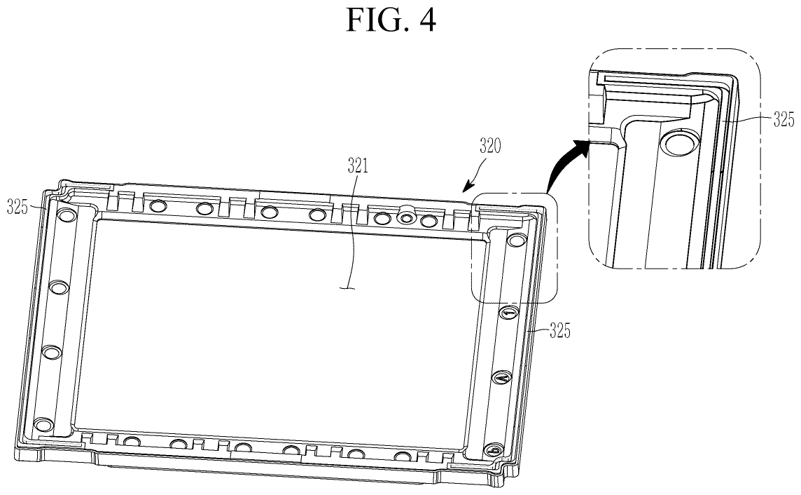

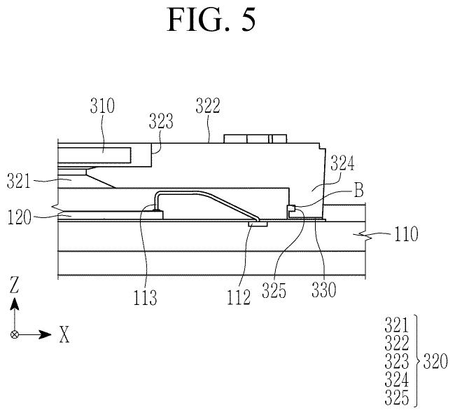

Hereinafter, the sub-housing 320 of the camera module 10, in accordance with one or more embodiments, will be described in more detail with reference to FIGS. 3 to 5. FIG. 3 illustrates a partial cross-sectional view taken along a line V-V′ of FIG. 2, FIG. 4 illustrates a sub-housing of an example camera module according to an embodiment, and FIG. 5 illustrates a cross-sectional view showing an adhesion state of the sub-housing shown in FIG. 3.

The sub-housing 320 includes an upper surface portion 322 having a hollow portion 321, a seating portion 323 on which the optical filter 310 is disposed, and a base portion 324 that may be coupled to the circuit board 110. A groove portion 325 is disposed on an inner surface of the sub-housing 320.

In an example, the upper surface portion 322 may have an approximately quadrangular shape, and the hollow portion 321 extending through the sub-housing 320 in the optical axis direction may be formed at a center. The image sensor 120 may be disposed below the hollow portion 321, and light passing through the lens barrel 220 may be transmitted to the image sensor 120 through the hollow portion 321 of the upper surface portion 322.

The seating portion 323 may be formed to have a step at an edge of the hollow portion 321 with respect to the upper surface portion 322. That is, the seating portion 323 may be recessed to a predetermined depth in the upper surface portion 322 adjacent to the edge of the hollow portion 321 down the optical axis direction. The depth of the seating portion 323 in the optical axis direction may be equal to or greater than a thickness of the optical filter 310. Accordingly, when the optical filter 310 is disposed on the seating portion 323, the optical filter 310 may be disposed on the same plane as the upper surface portion 322 or may be disposed below the upper surface portion 322 in the optical axis direction.

The base portion 324, which is a portion where the sub-housing 320 is coupled to the circuit board 110, may be formed to extend downward from an edge of the upper surface portion 322 in the optical axis direction. In this example, for stable coupling of the sub-housing 320 and the circuit board 110, a height of the base portion 324 in the optical axis direction may be formed to be equal to, or greater than, a depth of the seating portion 323.

Additionally, a bonding layer 330 may be disposed between the sub-housing 320 and the circuit board 110. The bonding layer 330, which is a layer that couples the sub-housing 320 to the circuit board 110, may be formed on the surface of the base portion 324 that faces the circuit board 110. The bonding layer 330 may include various adhesive materials, such as, but not limited to, ultraviolet curing adhesives or heat-curing adhesives, and may include any possible adhesive devices such as adhesive tapes.

The groove portion 325 may be disposed on an inner surface of the sub-housing 320. In an example, the groove portion 325 may be disposed on the lower surface of the upper surface portion 322, i.e., a surface facing the image sensor 120, or may be disposed on an inner side surface of the base portion 324.

The groove portion 325 may be formed to be spaced apart from a surface of the sub-housing 320 facing the circuit board 110. For example, the groove portion 325 may be disposed at a predetermined distance above the optical axis direction at a lower portion of the base portion 324, may be recessed in the optical axis direction on a lower surface of the upper portion 322, or may be formed by recessing an inner side surface of the base portion 324 in a direction perpendicular to an optical axis (x-axis direction). That is, the groove portion 325 may be formed on the lower surface of the upper surface portion 322 in a concave shape that is smaller than a thickness of the upper surface portion 322, or may be formed on the inner side surface of the base portion 324 to be less than a thickness of the base portion 324 in the direction perpendicular to the optical axis (x-axis direction).

The groove portion 325 may be disposed on at least one surface of inner surfaces of the sub-housing 320, and may be disposed corresponding to a region where the bonding wire 113 is disposed. The groove portion 325 may be disposed around at least a portion of the region where the bonding wire 113 is disposed.

In an example, when the sub-housing 320 has a structure of a substantially quadrangular frame shape with an upper surface portion, the groove portions 325 may be disposed on a lower surface of the upper surface portion or on four inner side surfaces. When the groove portion 325 is disposed on the lower surface of the upper surface portion, the groove portion 325 may be disposed along all corners of the quadrangular shape of the lower surface, may be disposed along two of the four corners facing each other corresponding to the bonding wire 113, or may be disposed along two entire corners facing each other and a portion of an adjacent corner corresponding to the bonding wire 113. When the groove portion 325 is disposed on the four inner side surfaces, the groove portion 325 may be disposed on all the four inner side surfaces, may be disposed on two inner side surfaces facing each other, corresponding to the bonding wire 113, among the four inner side surfaces, or may be disposed on the entire two inner side surfaces facing each other corresponding to the bonding wire 113 among the four inner side surfaces and on a portion of adjacent inner side surfaces.

Referring to FIG. 4, the groove portion 325 may be disposed throughout a longitudinal direction (y-axis direction) on two inner side surfaces of the sub-housing 320 facing each other corresponding to the bonding wire 113, and may be disposed in a portion in the longitudinal direction (x-axis direction) on the other two inner side surfaces facing each other adjacent to each of the two inner side surfaces.

The groove portion 325 may be disposed continuously or discontinuously on at least one surface of inner surfaces of the sub-housing 320. When disposed discontinuously, the groove portion 325 may include a plurality of slits disposed at predetermined intervals on at least one surface of the inner surfaces of the sub-housing 320. For the slits, adjacent slits may be arranged in a straight line in the longitudinal direction (y-axis direction) of the inner surface of the sub-housing 320, or may be arranged at different distances from a lower end of the sub-housing 320. In the latter case, the slits may be arranged such that adjacent slits and end portions in the longitudinal direction (y-axis direction) on the inner surface of the sub-housing 320 partially overlap in the optical axis direction. In this way, the groove portion 325 may be modified in various ways in disposition or shape.

Referring to FIG. 5, the groove portion 325 may accommodate some of the adhesive materials constituting the bonding layer 330. If the optical filter module 300 is fixed to the circuit board 110 through the bonding layer 330, when the bonding layer 330 hardens, the adhesive material may overflow into an inner surface of the sub-housing 320, and the adhesive material B flowing upward in the optical axis direction along the inner surface of the sub-housing 320 may be accommodated in the groove portion 325.

The adhesive material B overflowing from the bonding layer 330 may be accommodated in the groove portion 325, so the adhesive material may be prevented from contaminating the bonding wire 113, or may be prevented from flowing to an inner surface of the sub-housing 320 facing an upper surface of the bonding wire 113. This may prevent the bonding wire 130 and the sub-housing 320 from adhering to each other, thereby preventing connection performance between the image sensor 120 and the circuit board 110 from being deteriorated or the connection from becoming unstable. Accordingly, even if a slight impact is applied after the camera module 10 is completed, a risk of disconnection of the bonding wire 113 between the image sensor 120 and the circuit board 110 may be reduced.

In this way, according to the present embodiment, there is an effect of minimizing connection defects of the bonding wire 113 by preventing the adhesive material from overflowing from the bonding layer 330 while maintaining a height of the sub-housing 320 in the optical axis direction.

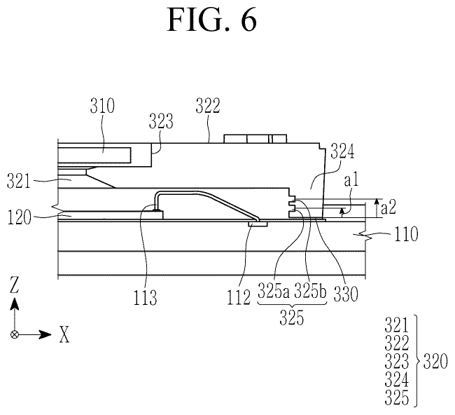

FIG. 6 illustrates a cross-sectional view showing a portion of an example camera module, in accordance with one or more embodiments.

Referring to FIG. 6, the example camera module, in accordance with one or more embodiments, has substantially the same configuration as that of the embodiment described with reference to FIGS. 1 to 5. However, in the present embodiment, two groove portions 325 may be disposed on the inner surface of the sub-housing 320. Hereinafter, different configurations will be described, the same reference numerals will be used for the same configuration, and configurations not separately described may be provided similarly to the embodiment shown in FIGS. 1 to 5.

In the present embodiment, the groove portion 325 may include a first groove portion 325a spaced apart from the surface of the sub-housing 320 facing the circuit board 110 by a first distance a₁, and a second groove portion 325b spaced apart from the surface of the sub-housing 320 facing the circuit board 110 by a second distance a₂ above the first groove portion 325a in the optical axis direction.

The second groove portion 325b may accommodate the adhesive material overflowing from the first groove portion 325a. That is, when the bonding layer 330 hardens, the adhesive material flowing to an inner surface of the base portion 324 may be primarily accommodated in the first groove portion 325a, and the adhesive material overflowing from the first groove portion 325a may be secondarily accommodated in the second groove portion 325b. A depth of the first groove portion 325a and a depth of the second groove portion 325b may be the same or different. According to the present embodiment, the groove portion 325 may be formed of two groove portions to more clearly prevent overflow of the adhesive material flowing into the inner surface of the sub-housing 320.

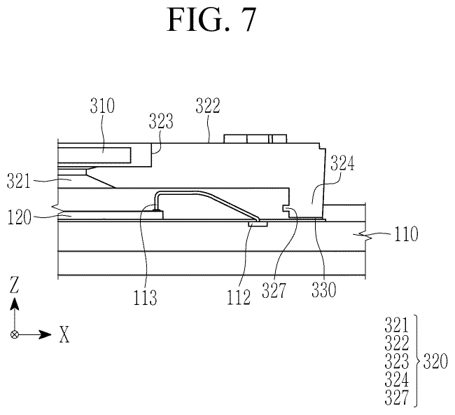

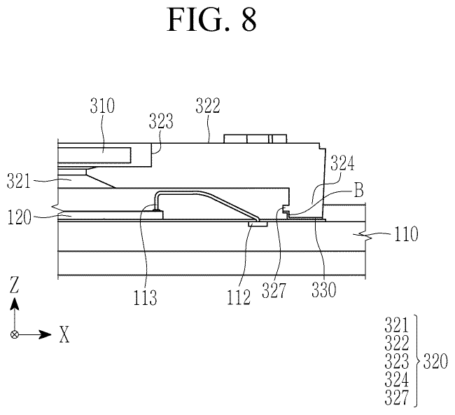

FIG. 7 illustrates a cross-sectional view of a portion of an example camera module, in accordance with one or more embodiments, and FIG. 8 illustrates a cross-sectional view of an adhesion state of the sub-housing shown in FIG. 7.

Referring to FIG. 7 and FIG. 8, the camera module, in accordance with the present embodiment, has substantially the same configuration as that of the embodiment described with reference to FIGS. 1 to 5. However, in the present embodiment, a protrusion 327 may be disposed on the inner surface of the sub-housing 320. Hereinafter, different configurations will be described, the same reference numerals will be used for the same configuration, and configurations not separately described may be provided similarly to the embodiment shown in FIGS. 1 to 5.

In the present embodiment, the sub-housing 320 includes an upper surface portion 322 having a hollow portion 321, a seating portion 323 on which the optical filter 310 is disposed, and a base portion 324 coupled to the circuit board 110. The protrusion 327 is disposed on the inner surface of the sub-housing 320.

The protrusion 327 may be disposed on the inner surface of the sub-housing 320. In an example, the protrusion 327 may be disposed on the lower surface of the upper surface portion 322, i.e., a surface facing the image sensor 120, or may be disposed on an inner side surface of the base portion 324.

The protrusion 327 may be formed to be spaced apart from a surface of the sub-housing 320 facing the circuit board 110. In an example, the protrusion 327 may be disposed at a predetermined distance above the optical axis direction at a lower portion of the base portion 324, may protrude in the optical axis direction on a lower surface of the upper surface portion 322, or may be formed by recessing an inner side surface of the base portion 324 in a direction perpendicular to an optical axis (x-axis direction). That is, the protrusion 327 may be formed in a convex shape on the lower surface of the upper surface portion 322 or the inner side surface of the base portion 324.

The protrusion 327 may be disposed on at least one surface of inner surfaces of the sub-housing 320, and may be disposed corresponding to a region where the bonding wire 113 is disposed. The protrusion 327 may be disposed around at least a portion of the region where the bonding wire 113 is disposed.

In an example, when the sub-housing 320 has a structure of a substantially quadrangular frame shape with an upper surface portion, the protrusion 327 may be disposed on a lower surface of the upper surface portion or on four inner side surfaces. When the protrusion 327 is disposed on the lower surface of the upper surface portion, the protrusion 327 may be disposed along all four corners of the quadrangular shape of the lower surface, may be disposed along two of the four corners facing each other corresponding to the bonding wire 113, or may be disposed along two entire corners facing each other and a portion of an adjacent corner corresponding to the bonding wire 113. When the protrusion 327 is disposed on the four inner side surfaces, the protrusion 327 may be disposed on all four inner side surfaces, may be disposed on two inner side surfaces facing each other, corresponding to the bonding wire 113, among the four inner side surfaces, or may be disposed on the entire two inner side surfaces facing each other corresponding to the bonding wire 113 among the four inner side surfaces and on a portion of adjacent inner side surfaces.

The protrusion 327 may be disposed continuously or discontinuously on at least one surface of the sub-housing 320. When disposed discontinuously, the protrusion 327 may include a plurality of protrusions disposed at predetermined intervals on at least one surface of the inner surfaces of the sub-housing 320. For the protrusions, adjacent protrusions may be arranged in a straight line in the longitudinal direction (y-axis direction) of the inner surface of the sub-housing 320, or may be arranged at different distances from a lower end of the sub-housing 320. In the latter example, the protrusions may be arranged such that adjacent protrusions and end portions in the longitudinal direction (y-axis direction) on the inner surface of the sub-housing 320 partially overlap in the optical axis direction. In this way, the protrusion 327 may be modified in various ways in disposition or shape.

Referring to FIG. 8, the protrusion 327 may accommodate some of adhesive materials constituting the bonding layer 330. If the optical filter module 300 is fixed to the circuit board 110 through the bonding layer 330, when the bonding layer 330 hardens, the adhesive material may overflow into an inner surface of the sub-housing 320, and the adhesive material B flowing upward in the optical axis direction along the inner surface of the sub-housing 320 may be accommodated in a lower portion of the protrusion 327. Accordingly, it is possible to prevent the adhesive material from contaminating the bonding wire 113 or from adhering to the bonding wire 113 and the sub-housing 320.

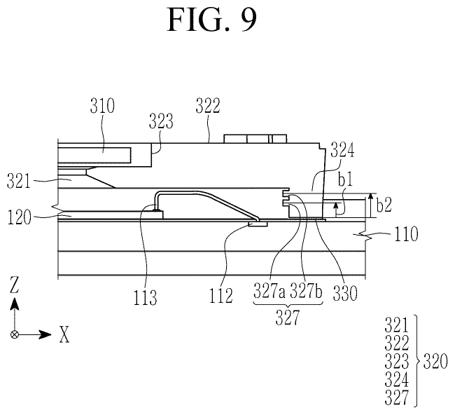

FIG. 9 illustrates a cross-sectional view of a portion of an example camera module, in accordance with one or more embodiments.

Referring to FIG. 9, the example camera module, in accordance with one or more embodiments, has substantially the same configuration as that of the embodiment described with reference to FIGS. 1 to 5. However, in the present embodiment, two protrusions 327 may be disposed on the inner surface of the sub-housing 320. Hereinafter, different configurations will be described, the same reference numerals will be used for the same configuration, and configurations not separately described may be provided similarly to the embodiment shown in FIGS. 1 to 5.

In the present embodiment, the protrusion 327 may include a first protrusion 327a spaced apart from the surface of the sub-housing 320 facing the circuit board 110 by a first distance b₁, and a second protrusion 327b spaced apart from the surface of the sub-housing 320 facing the circuit board 110 by a second distance b₂ above the first protrusion 327a in the optical axis direction.

The second protrusion 327b may accommodate the adhesive material overflowing from the first protrusion 327a. That is, when the bonding layer 330 hardens, the adhesive material flowing to an inner surface of the base portion 324 may be primarily accommodated in the first protrusion 327a, and the adhesive material overflowing from the first protrusion 327a may be secondarily accommodated in the second protrusion 327b. A height of the first protrusion 327a and a height of the second protrusion 327b may be the same or different. According to the present embodiment, the protrusion 327 may be formed of two protrusions in order to more clearly prevent overflow of the adhesive material flowing into the inner surface of the sub-housing 320.

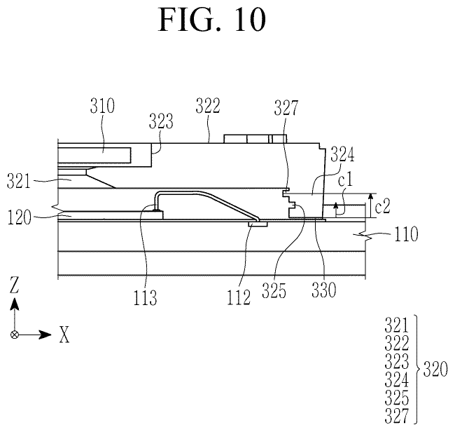

FIG. 10 illustrates a cross-sectional view showing a portion of an example camera module, in accordance with one or more embodiments.

Referring to FIG. 10, the example camera module according to the present embodiment has substantially the same configuration as that of the embodiment described with reference to FIGS. 1 to 5. Hereinafter, different configurations from the embodiment shown in FIGS. 1 to 5 will be described, the same reference numerals will be used for the same configuration, and configurations not separately described may be provided similarly to the embodiment shown in FIGS. 1 to 5.

Referring to FIG. 10, the sub-housing 320 includes an upper surface portion 322 having a hollow portion 321, a seating portion 323 on which the optical filter 310 is disposed, and a base portion 324 coupled to the circuit board 110. The groove portion 325 and the protrusion 327 are disposed on the inner surface of the sub-housing 320.

In the present embodiment, the groove portion 325 may be spaced apart by a first distance c₁ from a surface of the sub-housing 320 facing the circuit board 110, and the protrusion 327 may be further spaced apart from the surface of the sub-housing 320 facing the circuit board 110 than the groove portion 325. That is, the protrusion 327 may be formed to be spaced apart by a second distance c₂ from a surface of the sub-housing 320 facing the circuit board 110.

The protrusion 327 may accommodate the adhesive material overflowing from the groove portion 325. That is, when the bonding layer 330 hardens, the adhesive material flowing to the inner surface of the sub-housing 320 is primarily accommodated in the groove portion 325, and the adhesive material overflowing from the groove 325 may be secondarily accommodated at the lower portion of the protrusion 327. In an example, a depth of the groove portion 325 and a height of the protrusion 327 may be the same, or may be different. According to the present embodiment, the overflow of the adhesive material flowing into the inner surface of the sub-housing 320 may be more reliably prevented by forming a double configuration to accommodate the adhesive material overflowing from the bonding layer 330 with the groove portion 325 and the protrusion 327.

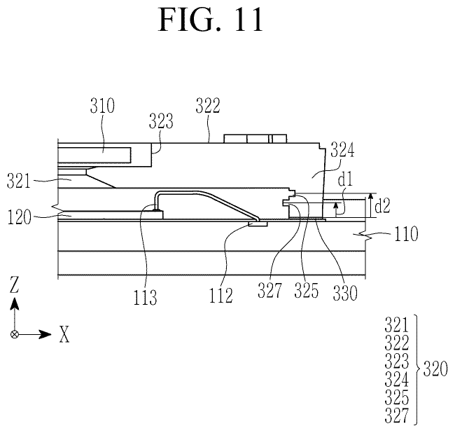

FIG. 11 illustrates a cross-sectional view showing a portion of a camera module according to another embodiment.

The example camera module according to the present embodiment has substantially the same configuration as that of the embodiment described with reference to FIGS. 1 to 5. Hereinafter, different configurations from the embodiment shown in FIGS. 1 to 5 will be described, the same reference numerals will be used for the same configuration, and configurations not separately described may be provided similarly to the embodiment shown in FIGS. 1 to 5.

Referring to FIG. 11, the sub-housing 320 includes an upper surface portion 322 having a hollow portion 321, a seating portion 323 on which the optical filter 310 is disposed, and a base portion 324 coupled to the circuit board 110. The protrusion 327 and a groove portion 325 may be disposed on the inner surface of the sub-housing 320.

In the present embodiment, the protrusion 327 may be spaced apart by a first distance d₁ from a surface of the sub-housing 320 facing the circuit board 110, and the groove portion 325 may be further spaced apart from the surface of the sub-housing 320 facing the circuit board 110 than the protrusion 327. That is, the groove portion 325 may be formed to be spaced apart by a second distance d₂ from a surface of the sub-housing 320 facing the circuit board 110.

The groove portion 325 may accommodate the adhesive material overflowing from the protrusion 327. That is, when the bonding layer 330 hardens, the adhesive material flowing to an inner surface of the base portion 324 may be primarily accommodated at a lower portion of the protrusion 327, and the adhesive material overflowing from the first protrusion 327 may be secondarily accommodated in the groove portion 325. A height of the protrusion 327 and a depth of the groove portion 325 may be the same or different. According to the present embodiment, the overflow of the adhesive material flowing into the inner surface of the sub-housing 320 may be more reliably prevented by forming a double configuration to accommodate the adhesive material overflowing from the bonding layer 330 with the groove portion 325 and the protrusion 327.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module, comprising:
a lens module comprising at least one lens;
an image sensor module comprising an image sensor disposed below the lens module, and a circuit board on which the image sensor is mounted; and
an optical filter module comprising an optical filter, and a sub-housing configured to support the optical filter, and disposed between the lens module and the image sensor module,
wherein a groove portion is disposed on an inner surface of the sub-housing, and the groove portion is spaced apart from a surface of the sub-housing that faces the circuit board.

2. The camera module of claim 1, wherein:
the image sensor is connected to the circuit board by a bonding wire, and
the groove portion is disposed around at least a portion of a region where the bonding wire is disposed.

3. The camera module of claim 1, further comprising:
a bonding layer disposed between the sub-housing and the circuit board,
wherein a portion of an adhesive material constituting the bonding layer is accommodated in the groove portion.

4. The camera module of claim 1, wherein the groove portion comprises:
a first groove portion that is spaced apart by a first distance from the surface of the sub-housing that faces the circuit board, and
a second groove portion that is spaced apart by a second distance from the surface of the sub-housing that faces the circuit board.

5. The camera module of claim 1, wherein:
a protrusion is further disposed on the inner surface of the sub-housing, and the protrusion is spaced further apart from the surface of the sub-housing that faces the circuit board than the groove portion.

6. The camera module of claim 1, wherein:
the sub-housing comprises a hollow upper surface portion, and a base portion that extends downward from an edge of the upper surface portion and is coupled to the circuit board, and
the groove portion is disposed on an inner surface of the base portion.

7. A camera module, comprising:
an image sensor;
a circuit board on which the image sensor is mounted;
an optical filter disposed on the image sensor; and
a sub-housing configured to support the optical filter,
wherein a protrusion is disposed on an inner surface of the sub-housing, and the protrusion is spaced apart from a surface of the sub-housing that faces the circuit board.

8. The camera module of claim 7, wherein:
the image sensor is connected to the circuit board by a bonding wire, and
the protrusion is disposed around at least a portion of a region where the bonding wire is disposed.

9. The camera module of claim 7, further comprising:
a bonding layer disposed between the sub-housing and the circuit board,
wherein a portion of an adhesive material constituting the bonding layer is accommodated at a lower portion of the protrusion.

10. The camera module of claim 7, wherein the protrusion comprises:
a first protrusion that is spaced apart by a first distance from the surface of the sub-housing that faces the circuit board, and
a second protrusion that is spaced apart by a second distance from the surface of the sub-housing that faces the circuit board.

11. The camera module of claim 7, wherein:
a groove portion is further disposed on the inner surface of the sub-housing, and the groove portion is spaced further apart from the surface of the sub-housing that faces the circuit board than the protrusion.

12. The camera module of claim 7, wherein:
the sub-housing comprises a hollow upper surface portion, and a base portion that extends downward from an edge of the upper surface portion and is coupled to the circuit board, and
the protrusion is disposed on an inner surface of the base portion.
